(19) United States
(12) Patent Application Publication
(10) Pub. No.: US 2024/0281832 A1
(43) Pub. Date: Aug. 22, 2024

(54) SYSTEM AND METHOD FOR IMPLEMENTING A TAX OPPORTUNITY ANALYZER AND DATA PLATFORM

(71) Applicant: KPMG LLP, New York, NY (US)

(72) Inventors: Brian TRAUMAN, North Caldwell, NJ (US); Madison Gabrielle ASBURY, Denver, CO (US); Brad L. BROWN, Pacific Palisades, CA (US); Michael K. FRANKLIN, Northbrook, IL (US); Joseph Edward UTKE, Denver, CO (US); Tejas Nitin VARIA, San Jose, CA (US); Taylor M. VERANTH, Denver, CO (US)

(21) Appl. No.: 18/111,181

(22) Filed: Feb. 17, 2023

(51) Int. Cl. G06Q 30/0202; G06Q 40/10

(52) U.S. Cl. CPC G06Q 30/0202; G06Q 40/10

(57) ABSTRACT

The invention relates to computer-implemented systems and methods that implement a tax opportunity analyzer. An embodiment of the present invention is directed to a multi-dimensional model (MDM) application that identifies cross functional opportunities by serving go-to-market (GTM) pillars of a professional services business in a unified framework. An embodiment of the present invention is directed to combining/aggregating data points relating to various companies. For example, the data points may relate to tax returns and other tax data. In this example, tax return data from thousands and thousands of clients from one or more tax service providers may be ingested and analyzed. Based on tax return and other data, an embodiment of the present invention may apply algorithms and formulas to identify opportunities and further prioritize the pursuit of the identified opportunities.

### FIELD OF THE INVENTION

The present invention relates to systems and methods for providing a tax analyzer and data platform.

### BACKGROUND

Service providers struggle to find opportunities for existing clients and develop meaningful connections with new clients. Current systems require a labor intensive and time-consuming process of examining each client and relationship on an individual basis for possible engagements. Oftentimes, events or changes, such as a change in tax law, may provide an opportunity. However, as events or changes become known, there is no easy way to identify clients that may benefit. As a result, only the clients that are top of mind are the ones that receive attention.

In addition, such opportunities may involve use of sensitive information that require permissions. To gain the proper clearances and permissions generally takes weeks. By then, the opportunity is stale and now lost.

It would be desirable, therefore, to have a system and method that could overcome the foregoing disadvantages of known systems.

### SUMMARY

According to one embodiment, the invention relates to a computer-implemented system for implementing a tax opportunity analyzer. The system comprises: an input interface that is configured to receive tax return data associated with a plurality of companies, wherein the input interface is further configured to receive data from a plurality of data sources; a user interface that is configured to communicate with a service provider via a communication network; and a computer server that is coupled to the input interface and the user interface and further configured to perform the steps of: ingesting, via the input interface, tax return data associated with the plurality of companies; identifying a request based on a fact pattern; responsive to the fact pattern, automatically generating a query that is applied to the tax return data to identify at least one tax opportunity; determining a benefit value that is available to a particular company for the at least one tax opportunity; determining a service provider value that is available to a service provider for the at least one tax opportunity; and providing, via the user interface, the at least one tax opportunity to the service provider.

According to another embodiment, the invention relates to a computer-implemented method for providing a tax opportunity analyzer. The method comprises the steps of: ingesting, via an input interface, tax return data associated with a plurality of companies, wherein the input interface is further configured to receive data from a plurality of data sources; identifying, via a computer server, a request based on a fact pattern; responsive to the fact pattern, automatically generating a query that is applied to the tax return data to identify at least one tax opportunity; determining, via the computer server, a benefit value that is available to a particular company for the at least one tax opportunity; determining, via the computer server, a service provider value that is available to a service provider for the at least one tax opportunity; and providing, via a user interface, the at least one tax opportunity to the service provider, wherein the user interface is configured to communicate with the service provider via a communication network.

An embodiment of the present invention is directed to a system and method that identifies opportunities, such as tax opportunities, by analyzing tax return data and/or other related information including third party or public data. Opportunities may be identified by executing queries based on fact patterns. After identifying and executing the query, an embodiment of the present invention may then examine the company's relationships to value each potential opportunity and further prioritize the pursuit of the opportunities. This may involve a predictive component that identifies which companies are more likely to engage a particular opportunity from a service provider. An embodiment of the present invention may identify next steps including lead contacts to facilitate a potential engagement.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flowchart, according to an embodiment of the present invention.

FIG. 2 is an exemplary system diagram, according to an embodiment of the present invention.

FIG. 3 is an exemplary interface, according to an embodiment of the present invention.

FIG. 4 is an exemplary interface, according to an embodiment of the present invention.

FIG. 5 is an exemplary interface, according to an embodiment of the present invention.

FIG. 6 is an exemplary interface, according to an embodiment of the present invention.

FIG. 7 is an exemplary interface, according to an embodiment of the present invention.

FIG. 8 is an exemplary interface, according to an embodiment of the present invention.

FIG. 9 is an exemplary interface, according to an embodiment of the present invention.

FIG. 10 is an exemplary interface, according to an embodiment of the present invention.

FIG. 11 is an exemplary flowchart, according to an embodiment of the present invention.

FIG. 12 is an exemplary system diagram, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to a multi-dimensional model (MDM) application that identifies cross functional opportunities by serving go-to-market (GTM) pillars of a professional services business in a unified framework.

An embodiment of the present invention is directed to combining/aggregating data points relating to various companies. The data points may be specific to a particular industry. For example, the data points may relate to tax returns and other tax data. In this example, tax return data from thousands and thousands of clients may be ingested and analyzed. Based on tax return and other data, an embodiment of the present invention may apply algorithms and formulas to identify opportunities and further prioritize the pursuit of the identified opportunities. Other data may include other types of data (e.g., client, third party, internal data, etc.).

An embodiment of the present invention may identify a new event such as new tax credit, change in law, etc. More specifically, an embodiment of the present invention may automatically identify companies/clients that have relevant fact patterns that could benefit from the new tax credit. An embodiment of the present invention may then determine a value to the client in terms of tax savings, credits, etc. as well as a value to the service provider represented by fees from the engagement including other benefits, advantages, etc. Based on the value determinations, an embodiment of the present invention may consider a service provider's relationships with each of those companies and further identify which companies are likely to engage or purchase the services based on additional factors. The additional factors may include type of customer, past/recent services/purchases, customer interest in certain content, information, etc. An internal lead contact (or other contact) may then be identified to facilitate the opportunity. These factors may be used to identify next steps and further streamline a sales/engagement process.

An embodiment of the present invention is directed to identifying opportunities; understanding client engagements and history; and then determining how to improve the client engagement (e.g., cross sell opportunities, etc.). This functionality may be implemented in a customer relationship management (CRM) system. Other system integrations may be realized.

An embodiment of the present invention may be particularly relevant for companies with multidisciplinary modules to improve management of opportunities in a holistic manner, as opposed to focusing on one specific limited area.

An embodiment of the present invention considers a company's standpoint relating to liquidity, market signals, past purchase histories, fact patterns to reinforce the opportunities identified as well as potentially downgrade assessments and scores. For example, an embodiment of the present invention may recognize that similar companies have engaged in a service in the past. However, a particular company may not have specific financial markers that would demand or benefit from this particular service.

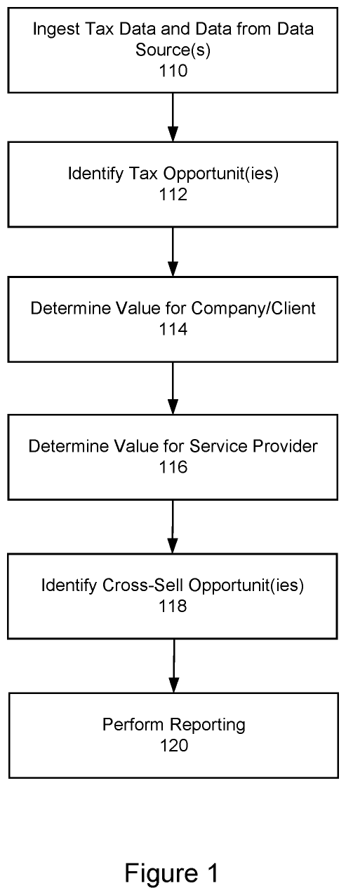

FIG. 1 is an exemplary flowchart, according to an embodiment of the present invention. At step 110, tax data and data from data sources may be ingested. At step 112, tax opportunities may be identified. At step 114, value from the tax opportunities may be identified for each company/client. At step 116, value for the service provider in servicing the tax opportunities may be determined. At step 118, cross-sell opportunities may be identified. At step 120, reporting may be performed. While the process of FIG. 1 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 110, tax data and data from data sources may be ingested. For example, data sources may include a database of tax returns from thousands and thousands of clients from a single service provider or a plurality of entities. Other data sources may include internal as well as external sources, e.g., government entity, newsfeeds, court systems, etc. For example, other data may include client data, client confidential information, business operations data, third party data, public data, external data, internal data, etc.

At step 112, tax opportunities may be identified. For example, an embodiment of the present invention may identify opportunities responsive to an event or a request. The event may include a new tax credit, an update in a tax law, a precedential case, etc. In another example, a service provider may submit a request that specifies a fact pattern. In addition, upon identifying an opportunity, the client's relationships, history and other related information may be considered in valuing the opportunity.

For example, if a company has a fact pattern that includes compensating foreign employees with equity, then the company may want to discuss corporate charge outs. An embodiment of the present invention may identify which companies have equity compensations and then further analyze corporate and individual tax returns.

In another example, if a company has a fact pattern that includes a cost-sharing agreement, then the company may want to discuss a recent court case that determines tax effects of cost-sharing agreements, and what planning might be advisable to achieve an optimal result and/or mitigate risks. An embodiment of the present invention may identify which companies have cost-sharing agreements and then further analyze corporate tax returns.

In yet another example, if a company has a fact pattern that includes having high cash ratios and/or debts maturing soon, then the company may want to discuss potential acquisition planning. An embodiment of the present invention may identify which companies have significant cash and debt maturity and then further analyze 10-Ks, annual reports and/or other government filings/documents.

An embodiment of the present invention may prioritize findings and potential opportunities and further facilitate discussions and connections with leads (e.g., lead tax partners (LTPs)) and/or other contacts.

At step 114, value from the tax opportunities may be identified for each company/client. For example, an embodiment of the present invention may apply the tax benefit to each qualifying client and identify a financial gain/savings/refund and/or other quantifiable benefit or advantage that may be obtained. An additional risk assessment may be performed. For example, potential hurdles including regulatory issues, privacy restrictions and/or other risks/impediments may be identified.

At step 116, value for the service provider in servicing the tax opportunities may be determined. An embodiment of the present invention may determine the amount of fees and other expenses that would be incurred by the service offered to the client for the identified opportunity. Based on the client data and other information, alternative fee arrangements may be generated and considered.

At step 118, cross-sell opportunities may be identified. Additional services that relate to and/or support the identified opportunity may be offered to the client. For a tax opportunity, services from advisory and/or audit and/or other tax services may be identified. This may further expand and solidify a current relationship. In addition, cross-sell opportunities may consider corporate structure, e.g., subsidiaries, affiliates, partners, etc. For example, if a service is implemented in a parent company, the subsidiaries may be more inclined to engage in the same or similar service. A successful engagement with the parent company may facilitate a similar engagement with a subsidiary or other affiliated entity.

Based at least in part on the determined values, an embodiment of the present invention may identify as well as prioritize/rank the tax opportunities using various factors including value to the company/client, value to the service provider, likelihood of success, potential for cross-sell, least/most risk, etc.

At step 120, reporting may be performed. Analytics and/or other metrics may be analyzed. This may be useful for feedback, refinement and improvement. Reporting may also include tracking usage, success, chances of success, value, etc.

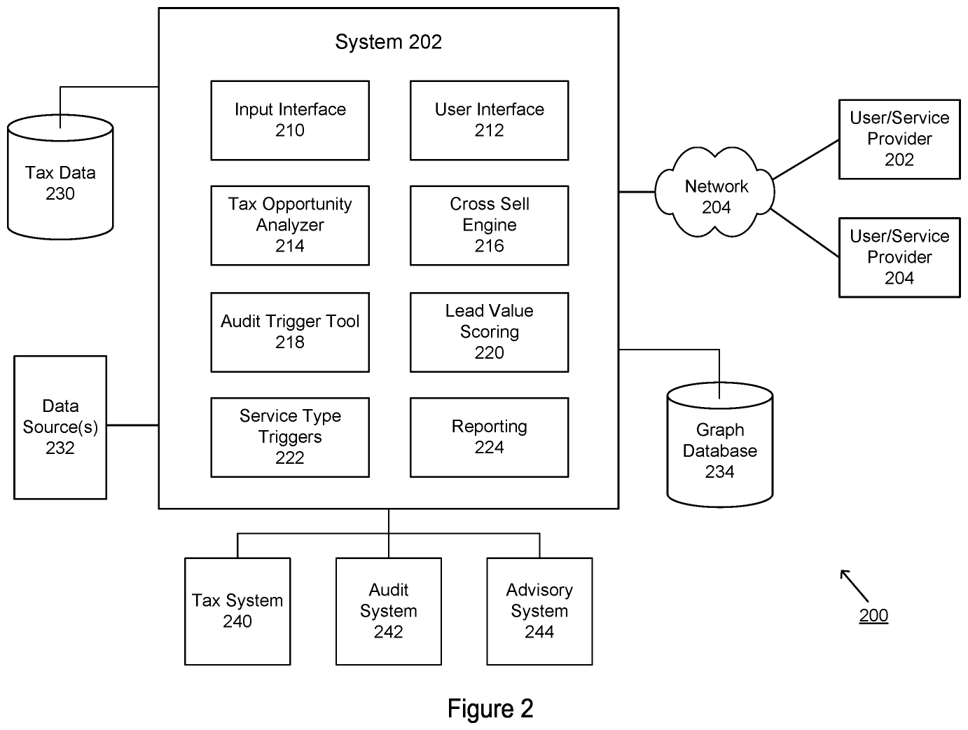

FIG. 2 illustrates an exemplary system, according to an embodiment of the present invention.

An embodiment of the present invention is directed to identifying opportunities responsive to events, requests, etc. Opportunities may be identified by executing queries based on fact patterns that align with the events or requests. After identifying and executing the query, an embodiment of the present invention may then examine the company's relationships. This may include the company's relationship with a current service provider as well as past engagements and behaviors. The company's behavior, activity, financial status and/or other information may be identified and considered.

An embodiment of the present invention is directed to a predictive component that identifies which companies are most likely to be interested or likely to engage/purchase. For example, a client's past engagements may be analyzed from a marketing perspective. This may involve identifying which accounts have a similar cross functional buying pattern that will result (or likely result) in an engagement. An embodiment of the present invention may identify next steps including lead contacts to connect with as well as other actions.

As shown in FIG. 2, Users 202, 204 may access System 202 via Network 204. System 202 may receive data from various sources including Tax Data 230, Data Sources 232 and Graph Database 234. Data Sources 232 may represent internal as well as external sources of information.

System 202 may be integrated and/or communicatively coupled with various other systems, such as Tax System 240, Audit System 242 and Advisory System 244. Other integrations, architectures and/or implementations may be supported.

System 202 may support various features and functions represented by Input Interface 210, User Interface 212, Tax Opportunity Analyzer 214, Cross Sell Engine 216, Audit Trigger Tool 218, Lead Value Scoring 220, Service Type Triggers 222 and Reporting 224.

Input Interface 210 may receive/ingest data from various data sources, including Tax Data 230, Data Sources 232 and Graph Database 234. Other data sources may include news sources, court systems, government entities, SEC filings, such as 10K, annual reports and other public filings.

Tax Data 230 may represent tax return data from various companies. For example, a SQL server may manage data relating to tax returns and/or other tax related data for thousands and thousands of companies. An embodiment of the present invention may identify opportunities by querying the SQL server to identify relevant fact patterns. For example, a query may be executed to identify companies with intercompany loans. The query identifies which companies are ripe for a certain type of tax treatment. With current systems, users would send an email and ask leads to look for relevant clients. With an embodiment of the present invention, a user may query a database based on a fact pattern to identify relevant companies. The query may identify specific fact patterns, e.g., on this line, in this form, at this dollar amount or greater.

Data Sources 232 may represent various internal as well as external data sources, including government entities, legal sources, court systems, SEC filings, etc.

Graph Database 234 may capture relationships between various datapoints/nodes. For example, data may be ingested directly through a data lake that processes graph data. The graph database as implemented may identify various relationships between accounts/services for a period of time, e.g., X number of years. This data may be used to apply certain fact patterns to identify how well a company fits a particular fact pattern. By identifying a same/similar industry as well as similar buying patterns, an embodiment of the present invention may identify a next best service for the client to consider.

User Interface 212 may represent an interactive interface that provides analysis in various formats, including dashboards, interactive interfaces, and/or other communications. User Interface 212 may be accessed by various user devices over communication network represented by Network 204.

Tax Opportunity Analyzer 214 may analyze tax data and identify opportunities based on an event or a request. An embodiment of the present invention analyzes data (e.g., tax returns, etc.) and applies a query to identify potential opportunities. An event may include various triggers such as a change in law/regulation/procedure, new court case, (or other binding precedent), a new tax benefit, etc. For example, based on a recent tax law change, a query may be executed to identify potential opportunities. In this example, the query may be formatted to identify fact patterns that apply to the tax law change, or facts that are newly applicable to existing tax law. For example, an embodiment of the present invention may recognize that under 26 U.S. Code § 451—credit for producing oil and gas from marginal wells, low-producing wells are eligible for a credit related to production volume with a 5 year carry-back. In this example, an embodiment of the present invention may uncover potential opportunities that benefit clients and produce revenue for a service provider.

The system then values the potential opportunities from the client perspective as well as the service provider perspective. The system may identify a lead contact or team to initiate communications and facilitate a potential engagement. Other actions may be supported.

An embodiment of the present invention is directed to generating and applying predictive features that further drill down client relationships and identify patterns.

Cross Sell Engine 216 may identify other services that complement the identified opportunity. This may include services that tend to sell well with (and/or support) the identified opportunity. Other factors may include similar buying patterns, relevancy/importance to the client's line of business or purpose, etc. For example, a recommended next service may be based on historical buying patterns. Cross Sell opportunities may cross over to other lines of businesses and services. For example, a service provider may offer tax services, audit services and advisory services. For a client that uses audit services, an embodiment of the present invention may offer a supporting tax service.

Audit Trigger Tool 218 may implement an algorithm that predicts a likelihood that a company will change auditors based on historical patterns predating an auditor change. For example, the model may be trained on a time period (e.g., past seven years, etc.) of audit change and company data. An audit trigger model may provide a metric (e.g., percentage, etc.) identifying the likelihood a company will change and a pursuit value (e.g., weighted fees based on likelihood to change, etc.) which may be reported in contextual views (e.g., benchmarking, time-series, etc.).

For example, Audit Trigger Tool 218 may apply machine learning to consider internal and external variables for a time period (e.g., ten year history, etc.) that identifies factors that tend to create an auditor change in a company. Using that fact pattern, an embodiment of the present invention may then extrapolate fact patterns to identify frequency of change, when such changes occur and further determine whether the particular company fits a similar fact pattern.

Lead Value Scoring 220 may generate scores and/or other metrics that assign value to account services recommendation. This may involve implementing a model that prioritizes and assigns value to specific services at a company based on engagement, opportunity history and/or interaction with marketing materials.

An embodiment of the present invention may further rank and prioritize opportunities from a pursuit standpoint to drive favorable outcomes and realize efficiencies in a holistic manner.

For example, an embodiment of the present invention may support a Lead Management feature that identifies leads and further values and prioritizes opportunities, such as a potential tax opportunity. The system may identify a contact or team associated with the client that may assist with communication and action. This may be further reinforced through an opportunity identified by a tax opportunity analyzer. Likewise, the tax opportunity analyzer may identify an opportunity with a prior engagement and contact.

Other factors that relate to Lead Value Scoring may include: a title of the person; when did the activity happen, size of the company, historical engagement, content that has been consumed, relationship to existing service lines, penetration in those service lines at those accounts, other behavior that relates to interest in products/services, etc. An embodiment of the present invention may score or assess each of those factors. For example, each activity type may have its own score and those scores/weights may be aggregated at an account level. These scores may identify the potential value of pursuing leads at those accounts. This may lead to identifying and targeting accounts with greater whitespace/greenspace and greater opportunity.

Service Type Triggers 222 may identify common account characteristics (e.g., financial performance, relationships, company facts, etc.) that precede the purchase of a given service. This may be applied to create common service type client profiles used to identify potential service opportunities.

Reporting 224 may provide analytics and reports based on the opportunities. Reporting may also be used to identify feedback and further improve accuracy and performance.

Users may communicate with System 202 via Network 204. System 202 may communicate and integrate with other devices and support various configurations and architectures. System 202 may support interactions on devices including mobile or computing device, such as a laptop computer, a personal digital assistant, a smartphone, a smartwatch, smart glasses, other wearables or other computing devices capable of sending or receiving network signals. System 202 may include computer components such as computer processors, microprocessors and interfaces to support applications including browsers, mobile interfaces, dashboards, interactive interfaces, etc. Other functions and features represented may be supported in various forms and implementations. While FIG. 2 illustrates individual devices or components, it should be appreciated that there may be several of such devices to carry out the various exemplary embodiments.

System 202 may be communicatively coupled to various data sources including any suitable data structure to maintain the information and allow access and retrieval of the information. Data Sources, such as 230, 232, 234, may be local, remote, cloud or network based. Communications with Data Sources may be over a network, or communications may involve a direct connection.

Networks may be a wireless network, a wired network or any combination of wireless network and wired network. Although Network 204 is depicted as one network for simplicity, it should be appreciated that according to one or more embodiments, Network 204 may comprise a plurality of interconnected networks, such as, for example, a service provider network, the Internet, a cellular network, corporate networks, or even home networks, or any of the types of networks mentioned above. Data may be transmitted and received via Network 204 utilizing a standard networking protocol or a standard telecommunications protocol.

The system 200 of FIG. 2 may be implemented in a variety of ways. Architecture within system 200 may be implemented as hardware components (e.g., module) within one or more network elements. It should also be appreciated that architecture within system 200 may be implemented in computer executable software (e.g., on a tangible, non-transitory computer-readable medium) located within one or more network elements. Module functionality of architecture within system 200 may be located on a single device or distributed across a plurality of devices including one or more centralized servers and one or more mobile units or end user devices. The architecture depicted in system 200 is meant to be exemplary and non-limiting. For example, while connections and relationships between the elements of system 200 are depicted, it should be appreciated that other connections and relationships are possible. The system 200 described above may be used to implement the various methods herein, by way of example. Various elements of the system 200 may be referenced in explaining the exemplary methods described herein.

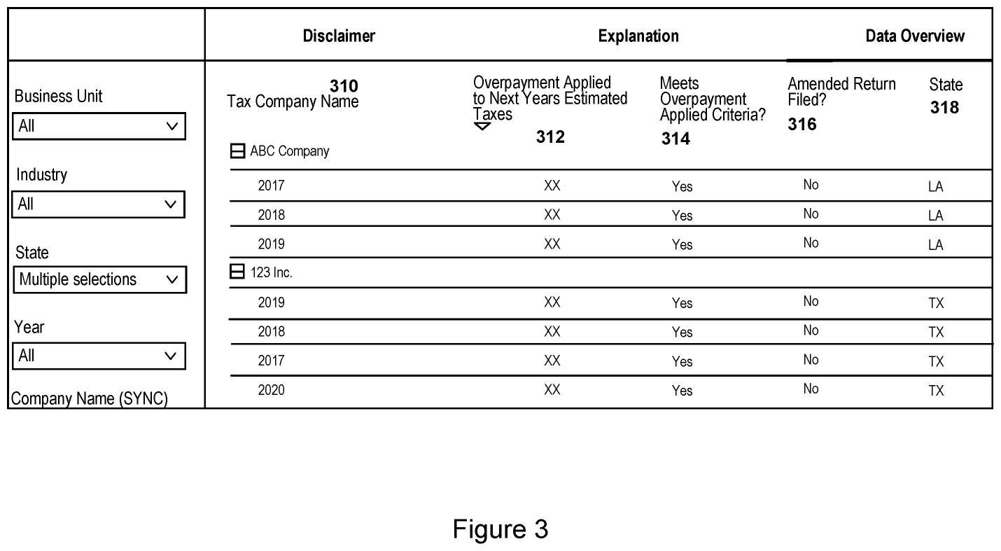

FIG. 3 is an exemplary interface, according to an embodiment of the present invention. FIG. 3 illustrates a quantified opportunity related to a “complex interest” service offering.

An embodiment of the present invention may recognize a new decision, such as a judicial opinion that changes the consequences of overpaying taxes to the IRS.

As shown in FIG. 3, an embodiment of the present invention may focus on companies with the largest value of overpayment over the longest duration. For a particular company at 310, an interface may provide overpayment 312, whether an overpayment criteria is met 314, whether an amended returned was filed 316 and relevant state or jurisdiction 318. This information may be provided on a yearly basis or other time period. In this example, an estimated value to company may be based on compounded interest while an estimated value to a service provider may be based on a contingency. The interface may also provide a sum of overpayment value, sum of value to the client and sum of value to the service provider. Other metrics and valuations may be provided.

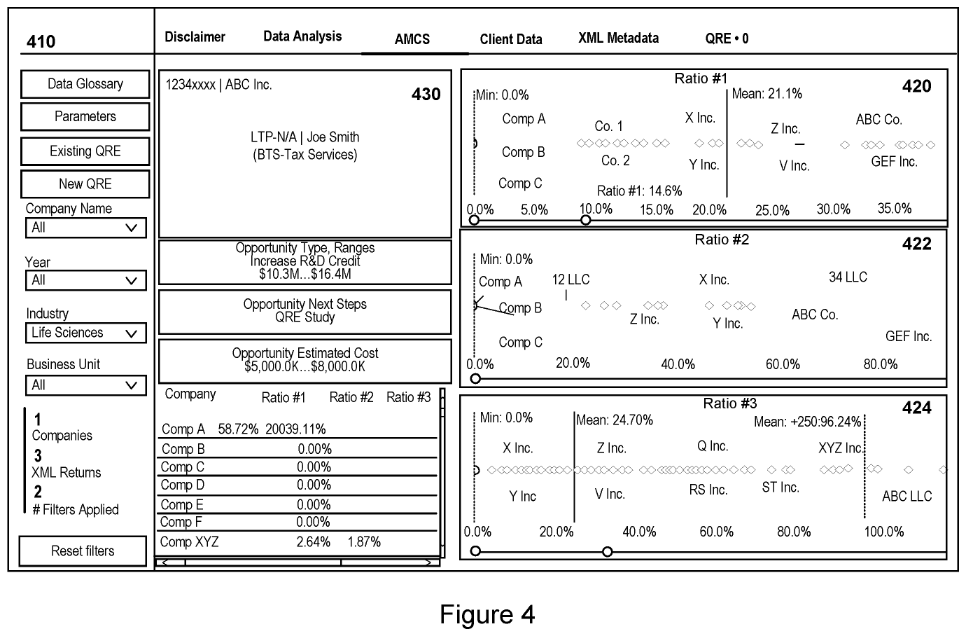

FIG. 4 is an exemplary interface, according to an embodiment of the present invention. FIG. 4 illustrates an opportunity in identifying research and development (R&D) credit.

A service provider may offer companies a feasibility study that involves recounting qualified research expenses (QRE) to increase R&D credit. The service provider may compare companies in the same industry, with a few ratios.

An embodiment of the present invention may look at all clients of a tax return preparation business at once, compare them in various ways and estimate potential value (or risk).

As shown on the left panel 410, the applicable industry is shown as life sciences. FIG. 4 also illustrates three representative graphs, demonstrating three different ratios relevant to this analysis, at 420, 422, and 424. Each dot represents a client in the life science industry. The graphs illustrate how far each dot is from the mean (based on all peers) and in which direction. A user is able to interact with each of the graphs to determine a potential opportunity. For example, if a client is illustrated as being low on all three graphs, an embodiment of the present invention may identify a potential opportunity as it is likely that the client has miscalculated an expense, such as qualified research expenses. A service provider may be engaged to address this miscalculation.

As shown by 430, an embodiment of the present invention may identify the opportunity (e.g., increase R&D credit in the range of $10.3 to 16.4M), provide next steps (e.g., QRE study) and provide an estimated cost (cost of fees, how much is that going to cost the company to engage the opportunity). In addition, the system identifies a contact to connect with (e.g., lead tax partner (LTP) in Business Tax Services (BTS)). The identified contact may represent the person with the deepest relationship which may be based on revenue generated. Other metrics and analysis may be applied.

Additional opportunities may be listed where the user may engage and interact with each.

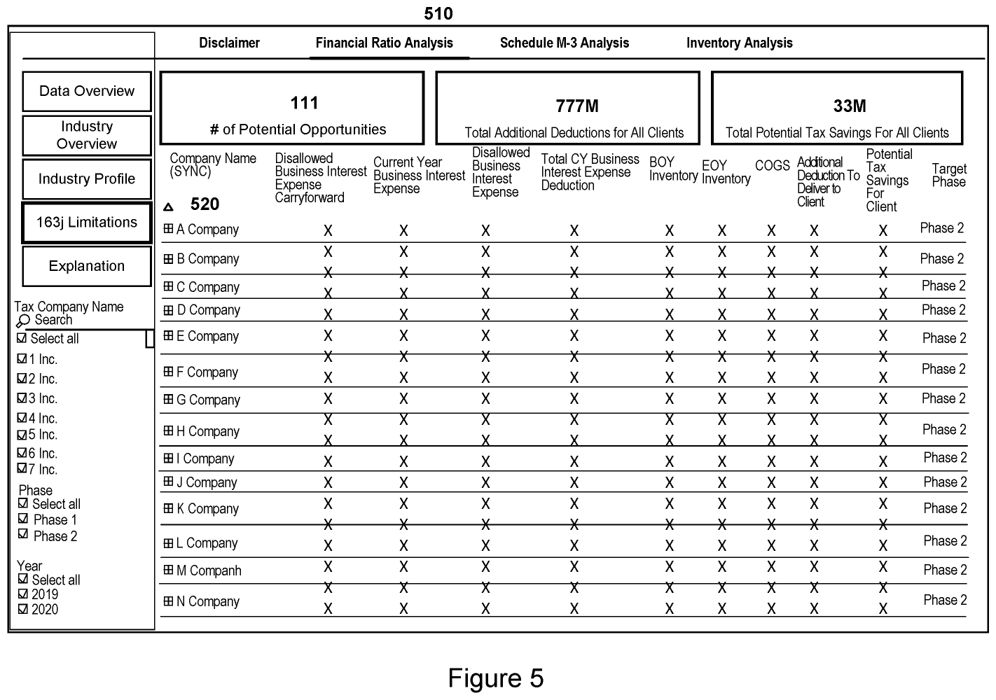

FIG. 5 is an exemplary interface, according to an embodiment of the present invention. Internal Revenue Code Section 163(j) limits deductions for business interest expense. In general, Code Section 163(j) disallows interest in excess of 30% of adjusted taxable income (ATI). An embodiment of the present invention seeks to identify and quantify all disallowed interest expense, for each tax return preparation client. This provides an opportunity to capitalize this disallowed interest to (1) bonus-eligible asset (e.g., software), and/or (2) inventory.

Bonus-eligible software may be estimated before connecting with a client. Inventory may be computed from tax returns (based on turnover). For a service provider, this may be valued in millions in fees, plus additional millions if § 163(j) is changed in the extenders.

As shown in FIG. 5, Financial Ratio Analysis 510 may be displayed. At the top panel, aggregate opportunities and savings may be provided, e.g. a number of potential opportunities, total additional deductions for all clients and total potential tax savings for all clients may be provided. Table 520 displays each company, relevant data related to their interest expenses, inventory, and costs of goods (COGS) sold. The third to last column displays the potential additional deduction that a client may be able to claim based on an algorithm analyzing that client's data. The second to last column displays the potential tax savings that client could realize as a result of that potential additional deduction. The last column indicates the priority of pursuing that opportunity, based on certain factors specific to the opportunity, such as filing deadlines.

For each company, analysis may include: disallowed business interest expense carryforward; current year business interest expense; disallowed business interest expense; total current year (CY) business interest expense deduction; beginning of year (BOY) inventory; end of year (EOY) inventory; COGS; additional dedication to deliver to client; potential tax savings for client; target phase; etc.

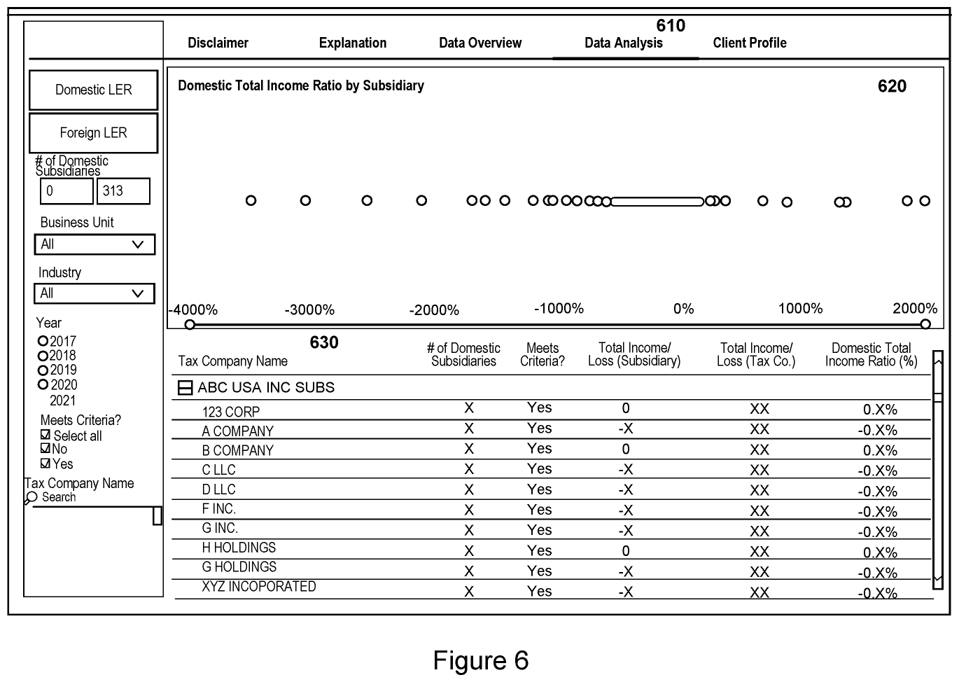

FIG. 6 is an exemplary interface, according to an embodiment of the present invention. FIG. 6 provides legal entity rationalization as shown by Data Analysis 610. FIG. 6 provides analysis relating to each company and their subsidiaries, affiliates, etc. This enables users to determine which entities are dormant, how many are considered dormant, whether these entities are foreign or domestic, and whether other entities are in the jurisdiction.

Panel 620 graphically illustrates domestic total income ratio by subsidiary. Panel 630 provides details relating to Tax Company Name; Number of Domestic Subsidiaries; whether criteria is met; Total Income Loss (Subsidiary); Total Income Loss (Tax Company); Domestic Total Income Ratio (%), etc.

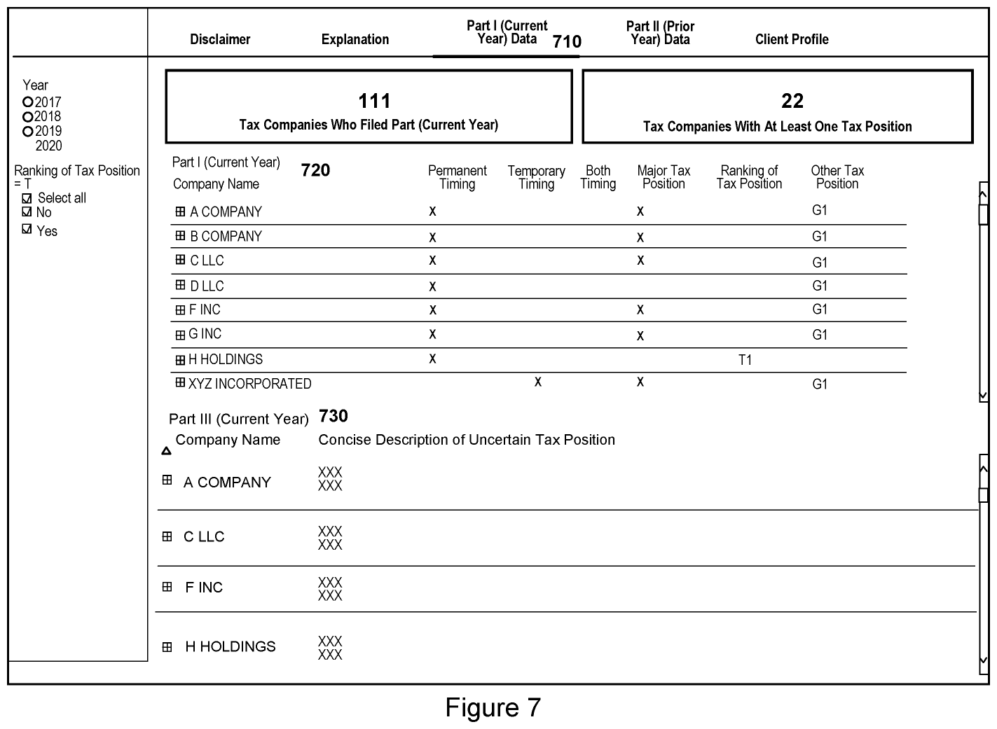

FIG. 7 is an exemplary interface, according to an embodiment of the present invention. FIG. 7 illustrates details relating to uncertain tax positions.

FIG. 7 provides details regarding which companies have filed a Schedule for Uncertain Tax Positions (UTP) and if so, what are those positions. This information may then be used to identify potential opportunities. As shown in FIG. 7, 111 companies filed uncertain tax positions (UTP) in 2020 and 22 tax companies with at least one Tax Position.

The opportunities may be examined by Tax Industry Leads and specialists for discussion areas. For example, UTP analysis may lead to opportunities for an Advance Pricing Agreement.

FIG. 7 provides analysis relating to Part I (Current Year) Data at 720 which may include Company Name; Permanent Timing; Temporary Timing; Both Timing; Major Tax Position; Ranking of Tax Position; and Other Tax Position.

As shown in FIG. 7, Part III (Current Year) at 730 may include a concise description of uncertain tax positions. This allows service providers to review certain clients, certain topics, certain years, etc. to identify valuable discussions with these clients regarding how to assist them with their tax returns.

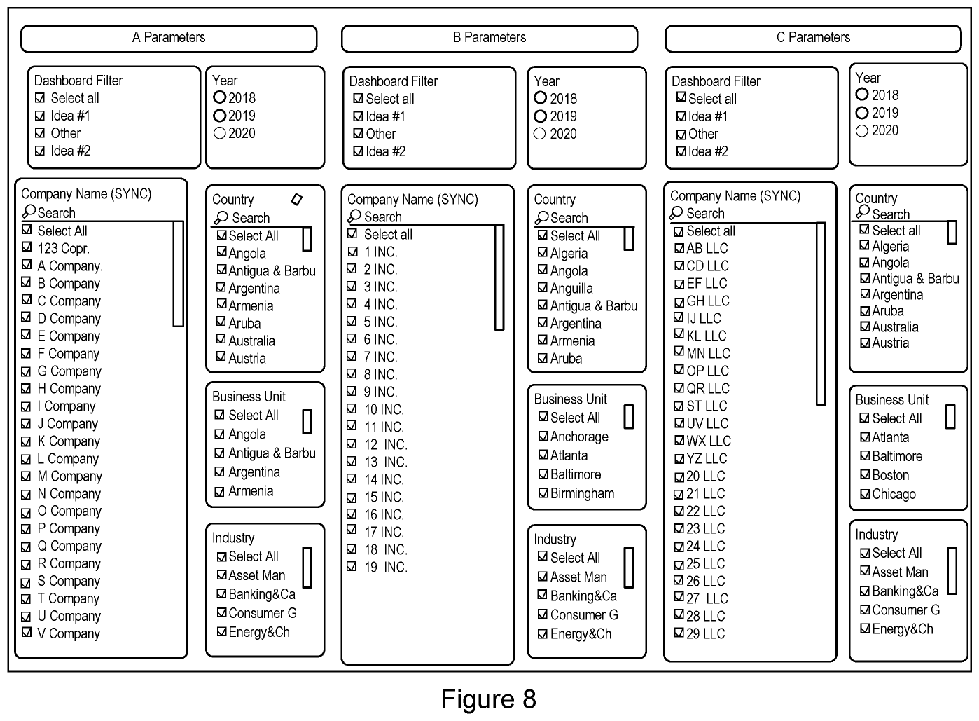

FIG. 8 is an exemplary interface, according to an embodiment of the present invention.

FIG. 8 illustrates analysis that relates to international tax filings. A user may search and filter results by identifying specific sets of parameters. For example, Form A Parameters may relate to a corporation's ownership/stock transactions/shareholders/company transactions, etc. with certain related parties. Form B Parameters may relate to a corporation's ownership/stock transactions/shareholders/company transactions etc. with other related parties. Form C Parameters may relate to other data about those related parties. Parameters may relate to dashboard filters, company name, year, country, business unit, etc.

FIG. 8 may provide analysis and insights regarding which companies have operations in a particular country, with certain characteristics. For example, it may include identifying which companies pay royalties, from which country, in what amount, and to whom.

The parameters may be “programmed” to show certain opportunities (e.g., Idea #1, Idea #2, etc.) where the output may be transmitted to another system for additional analysis and results.

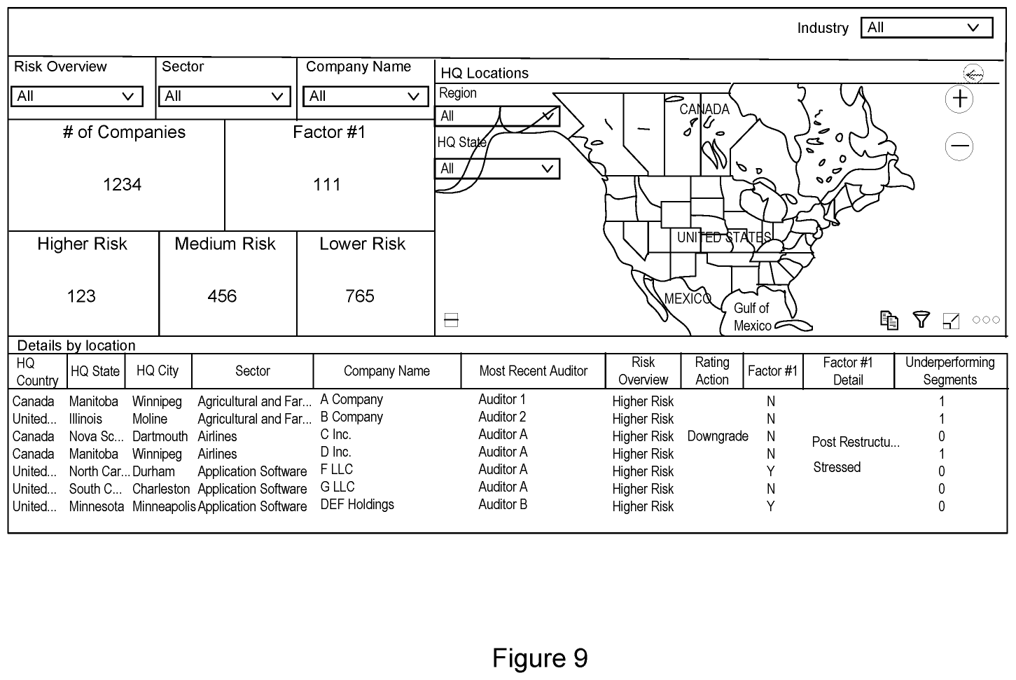

FIG. 9 is an exemplary interface, according to an embodiment of the present invention. FIG. 9 provides analysis and details relating to potentially distressed companies. The analysis may be used to predict bankruptcies, identify suppliers in need of support, and other merger and acquisition (M&A) activity. FIG. 9 also provides Risk Ranking for each company. Details may include a score that may be blended with rankings relating to: debt/earnings ratios, changes in free cash flow relative to debt, changes in margins, etc. A graphic illustrating HQ locations may also be provided via a map view, for example.

As shown in FIG. 9, the interface may include information such as risk overview, sector, company name, number of companies and other factors. In addition, the interface may identify varying levels of risk, including Higher Risk, Medium Risk and Lower Risk. Other variations in granularity and details may be applied. Details by location may include HQ country, HQ state, HQ City, Sector, Company Name, Most Recent Auditor, Risk Overview, Rating Action, Factor #1, Factor #1 Details; Underperforming Segments, etc.

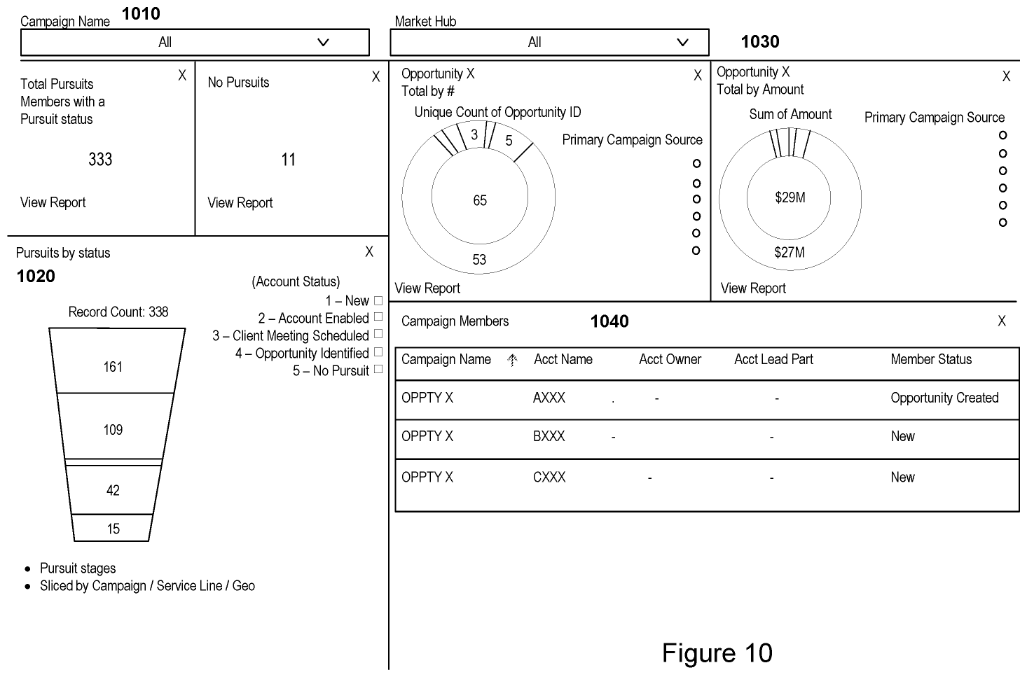

FIG. 10 is an exemplary interface, according to an embodiment of the present invention. FIG. 10 illustrates go-to-market (GTM) tracking and accountability. GTM provides a strategy or plan that details how an organization can engage with customers. The plan may further specify how a company will reach target customers and achieve competitive advantage.

As shown by 1010, Total Pursuits and No Pursuits are shown. At 1020, Pursuits by status are illustrated through a graphic. At 1030, Opportunities may be illustrated by number/count as well as amount. At 1040, Campaign information may include: Campaign Name; Account Name; Account Owner; Lead Part; and Member Status.

An embodiment of the present invention is directed to an Audit Trigger Insights platform. The platform delivers predictive results within relative context, on the direction of market definitions through the communication of metrics informed by: development and implementation of a machine learning model, such as a Random Forest machine learning model, and ingesting SME input to further inform the narrative. The platform achieves significant improvement on existing prototype ML models and further creates data visualization front-ends that communicate context, metrics, enable customizable benchmarking capabilities and identify potential value opportunities as well as account strategy for an account practice.

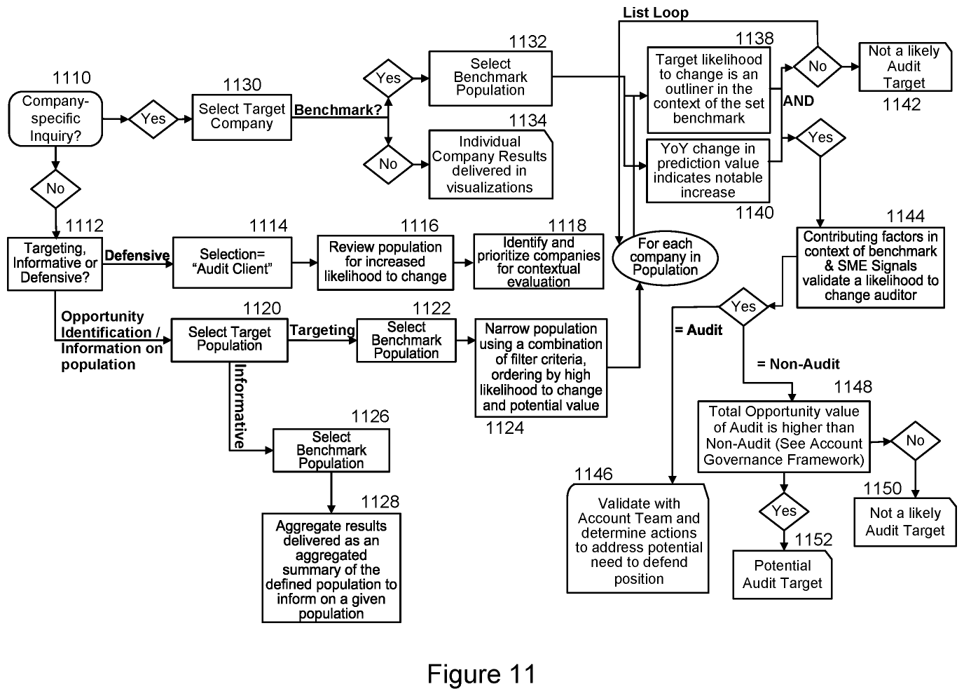

FIG. 11 is an exemplary flowchart, according to an embodiment of the present invention. FIG. 11 illustrates a business use process that determines whether an inquiry is a company-specific inquiry at 1110. If not, step 1112 may determine whether the inquiry is targeting, informative or defensive. If defensive, a selection is made to indicate an audit client at step 1114. At step 1116, population may be reviewed for increased likelihood of change. Step 1118 may then identify and prioritize companies for contextual evaluation.

If the inquiry is targeting or informative, step 1120 may select a target population. If Targeting, step 1122 may select a benchmark population. Step 1124 may then narrow the population using a combination of filter criteria, ordering by high likelihood to change and potential value. For example, filter criteria may include: company industry, company location, company revenue, model predicted value, company auditor, priority lists, potential account value, total fees and company name.

If the inquiry is informative, a benchmark population may be selected at step 1126. Step 1128 may then aggregate results delivered as an aggregated summary of the defined population to inform on a given population.

If the initial inquiry is company specific, a target company may be selected at 1130 and a benchmark determination may be made. If yes, benchmark population may be selected at 1132. If no, individual company results may be delivered in visualizations at 1134.

Step 1138 determines whether target likelihood to change is an outliner in the context of the set benchmark. Step 1140 determines whether year-over-year (YoY) change in prediction value indicates a notable increase. If both are no, step 1142 indicates the inquiry is not a likely audit target. If both are yes, step 1144 identifies contributing factors in context of the benchmark and SME signals validate a likelihood to change auditor. For audit, step 1146 validates with an account team and determines actions to address a potential need to defend a position. For non-audit, step 1148 determines whether a total opportunity value of audit is higher than non-audit. If no, step 1150 determines that the inquiry is not a likely audit target. If yes, step 1152 determines that the inquiry is a potential audit target.

While the process of FIG. 11 illustrates certain steps performed in a particular order, it should be understood that the embodiments of the present invention may be practiced by adding one or more steps to the processes, omitting steps within the processes and/or altering the order in which one or more steps are performed.

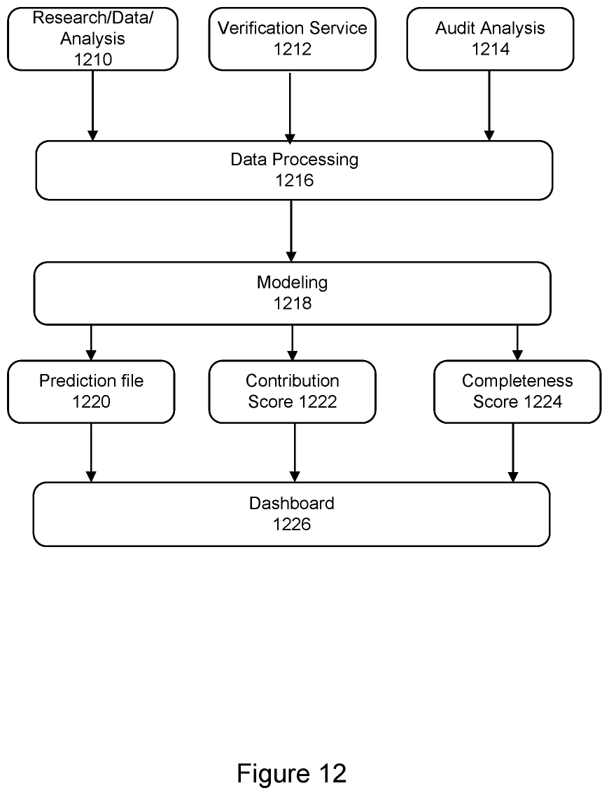

FIG. 12 is an exemplary system diagram, according to an embodiment of the present invention. FIG. 12 illustrates an audit trigger model process. Data may be sourced from various data sources including research data and analysis (e.g., Capital IQ), verification service (e.g., income verification express service (IVES)); and Audit Analytics (e.g., PCAOB). Additional sources may be supported.

At Data Processing 1216 and Modeling 1218, data from the three representative sources, 1210, 1212 and 1214, may be compiled in Python to create a training file that continually retrains a Random Forest model to learn from historical events. Other programming languages, models and machine learning algorithms may be applied.

Outputs from Modeling 1218 may include Prediction File 1220, Contribution Score 1222 and Completeness Score 1224. Prediction File 1220 may provide probabilities of an auditor change. For example, Prediction File may provide year wise probability of likelihood to change auditor for each company. It may also captures the year-over-year (YoY) percentage change of the prediction values. Contribution Score 1222 may represent Data Availability for the features. For example, Contribution Score 1222 may provide the importance of an individual category for each company (e.g., calculated using absolute values of Feature Values) and the rank of the features based on their important. Contribution Score 1224 may represent feature importance. For example, Completeness Score 1224 may provide a percentage of non-null values in a feature list year wise. These outputs may be used in a data visualization front-end represented by Dashboard 1226. Other outputs and/or scores may be supported.

As for feature importance, an audit trigger model may provide an importance score to various features (e.g., dependent variable) for predicted probabilities using a Random Forest machine learning algorithm implemented in Python, for example. A graphical representation via a dashboard or other interactive user interface may display a top number of features for one such probability score and categorize by the contribution based on different predicted classes.

Other data visualizations may include audit trigger insights reports including peer group details; contributing factors; feature evaluation; and model features.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the System software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

1. A computer-implemented system for providing a tax opportunity analyzer, the system comprising:
an input interface that is configured to receive tax return data associated with a plurality of companies, wherein the input interface is further configured to receive data from a plurality of data sources;
a user interface that is configured to communicate with a service provider via a communication network; and
a computer server that is coupled to the input interface and the user interface and further implements a learning algorithm configured to perform the steps of:
ingesting, via the input interface, tax return data associated with the plurality of companies;
identifying a request based on a fact pattern;
responsive to the fact pattern, automatically generating, via the learning algorithm, a query that is applied to the tax return data to;
predicting, via the learning algorithm and based on the generated query, the direction of one or more market definitions through the communication of a plurality of metrics informed by development of the learning algorithm;
identifying, via the learning algorithm, at least one tax opportunity based on the query and the prediction of the direction of the one or more market definitions;
determining, via the learning algorithm, a benefit value that is available to a particular company for the at least one tax opportunity;
determining, via the learning algorithm, a service provider value that is available to a service provider for the at least one tax opportunity;
providing, via the user interface, the at least one tax opportunity to the service provider.

2. The system of claim 1, wherein the request is automatically generated based on an event, or on receiving new data for a company.

3. The system of claim 1, wherein the event is one or more of: a change in tax law, a request from the service provider or in response to a court case.

4. The system of claim 1, wherein the input interface that is further configured to receive client confidential information, business operations data and public data.

5. The system of claim 1, wherein the computer server is further configured to perform the step of:
identifying at least one cross-sell opportunity that is related to the at least one tax opportunity.

6. The system of claim 1, wherein the benefit value comprises a tax benefit to the particular company.

7. The system of claim 1, wherein the user interface further provides a tax partner contact related to the at least one tax opportunity to facilitate an engagement.

8. The system of claim 1, wherein the at least one tax opportunity comprises a plurality of tax opportunities that are prioritized based at least in part on the benefit value and the service provider value.

9. The system of claim 1, wherein the benefit value comprises at least one tax deduction or at least one potential tax saving.

10. The system of claim 1, wherein the service provider value comprises one or more of: fee estimate, expense estimate and risk assessment.

11. A computer-implemented method for providing a tax opportunity analyzer, the method comprising the steps of:
ingesting, via an input interface, tax return data associated with a plurality of companies, wherein the input interface is further configured to receive data from a plurality of data sources;
identifying, via a computer server, a request based on a fact pattern;
responsive to the fact pattern, automatically generating, via a learning algorithm of the computer server, a query that is applied to the tax return data;
predicting, via the learning algorithm and based on the generated query, the direction of one or more market definitions through the communication of a plurality of metrics informed by development of the learning algorithm;
identifying, via the learning algorithm, at least one tax opportunity based on the query and the prediction of the direction of the one or more market definitions;
determining, via the learning algorithm, a benefit value that is available to a particular company for the at least one tax opportunity;
determining, via the learning algorithm, a service provider value that is available to a service provider for the at least one tax opportunity;
providing, via a user interface, the at least one tax opportunity to the service provider, wherein the user interface is configured to communicate with the service provider via a communication network.

12. The method of claim 11, wherein the request is automatically generated based on an event, or on receiving new data for a company.

13. The method of claim 11, wherein the event is one or more of: a change in tax law, a request from the service provider or in response to a court case.

14. The method of claim 11, wherein the input interface that is further configured to receive client confidential information, business operations data and public data.

15. The method of claim 11, further comprising the step of:
identifying at least one cross-sell opportunity that is related to the at least one tax opportunity.

16. The method of claim 11, wherein the benefit value comprises a tax benefit to the particular company.

17. The method of claim 11, wherein the user interface further provides a tax partner contact related to the at least one tax opportunity to facilitate an engagement.

18. The method of claim 11, wherein the at least one tax opportunity comprises a plurality of tax opportunities that are prioritized based at least in part on the benefit value and the service provider value.

19. The method of claim 11, wherein the benefit value comprises at least one tax deduction or at least one potential tax saving.

20. The method of claim 11, wherein the service provider value comprises one or more of: fee estimate, expense estimate and risk assessment.

21. The system of claim 8, wherein the computer server is further configured to perform the step of:
generating a recommended course of action based on the prioritized plurality of tax opportunities.

22. The method of claim 18, further comprising the step of:
generating a recommended course of action based on the prioritized plurality of tax opportunities.

23. The system of claim 1, wherein the computer server is further configured to perform the step of:
rank each of the at least one tax opportunity relative to each other, said ranking based on the benefit value, the service provider value, a likelihood of success predicted by the learning algorithm, and a potential for cross-selling a service associated with each of the at least one tax opportunity.

24. The system of claim 1, wherein the providing the at least one tax opportunity is based on a prediction of success made by the learning algorithm and based at least in part on a relationship history between the particular company and the service provider.

25. The method of claim 11, further comprising the step of:
ranking each of the at least one tax opportunity relative to each other, said ranking based on the benefit value, the service provider value, a likelihood of success predicted by the learning algorithm, and a potential for cross-selling a service associated with each of the at least one tax opportunity.

26. The method of claim 11, wherein the providing the at least one tax opportunity is based on a prediction of success made by the learning algorithm and based at least in part on a relationship history between the particular company and the service provider.

27. The system of claim 1, wherein the computer server is further configured to provide, via the user interface, an interactive user visualization of the at least one tax opportunity, said visualization comprising a plurality of ratio graphs comparing the particular company to a plurality of other companies in a given industry.

28. The system of claim 1, wherein the user interface is an interactive user interface that (a) provides for user selection of one or more specific parameters, the selected parameters are programmed to show at certain opportunities, and (b) transmits the output of the interactive user interface to at least one additional system for further analysis

29. The system of claim 1, wherein the machine learning algorithm is configured to determine and apply an importance score to one or more variables for predicted probabilities.
user interface is an interactive user interface that (a) provides for user selection of one or more specific parameters, the selected parameters are programmed to show at certain opportunities, and (b) transmits the output of the interactive user interface to at least one additional system for further analysis
